(19) United States
(12) Patent Application Publication
(10) Pub. No.: US 2003/0029171 A1
(43) Pub. Date: Feb. 13, 2003

(54) External rotor gas turbine

(76) Inventor: Bret Edward Cahill, Beaumont, TX (US)

Correspondence Address: Bret Cahill, P.O. Box 6322, Beaumont, TX, 77725, US

(21) Appl. No.: 10/090,260

(22) Filed: Sep. 30, 2002

Related U.S. Application Data
(60) Provisional application No. 60/273,426, filed on Mar. 5, 2001.

(51) Int. Cl. F02G 3/00

(52) U.S. Cl. 60/726; 60/805

(57) ABSTRACT

An external rotor gas turbine engine to provide direct high speed thrust or to provide rotational shaft work to power electrical generators or aircraft engine fans. To supply compressed air to the rotating inlet of the turbine or combustor, the dynamic compressor has an external rotor journaled onto an internal stator. The entire outside of the engine rotates allowing for a sealless high pressure rotating air source to the exoskeletal turbine. For the prime mover embodiment, the residual kinetic energy from the rotating nozzles may be recovered by an impulse turbine. For the high speed propulsion engine, the impulse turbine is replaces with stator vanes to redirect the momentum in an axial direction.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND—FIELD OF INVENTION

This invention relates to gas turbine engines, specifically to external rotor reaction jet gas turbine engines.

### BACKGROUND—DESCRIPTION OF PRIOR ART

Brayton thermodynamic cycle internal combustion engines can be categorized by the type of machinery used to compress air and expand combustion gases. The common turbomachinery engine will have a finely bladed internal rotor dynamic compressor to compress air powered by a similar device to expand combustion gases. Unlike the centrifugal or axial compressors, however, the blades of the turbine are completely immersed in hot combustion gases. Extraordinary efforts at developing advanced alloys and sophisticated cooling techniques are necessary to keep the turbine blades operating at reasonably high inlet temperatures and efficiencies. Up to twenty five percent of compressor air is wasted in film cooling of some high performance gas turbine engines. Not only is the engine expensive to design and build, the overall efficiency is reduced by up to ten percent. Moreover, rotor tip clearance leakage losses are significant in an engine that must operate over a range of temperatures including cold start up.

Eliminating the bladed internal rotor of the gas turbine engine has, therefore, been a goal of many inventors for decades.

McNaught (U.S. Pat. No. 2,592,938) develops rotational shaft work to power a compressor by expanding combustion gases through nozzles mounted on the periphery of a pressure vessel for a jet reaction turbine. The conventional internal rotor compressor, however, requires a heavy external spinning linkage shell in order to be powered by the turbine. The engine is impractical to fabricate or operate.

More recently, Lawler (U.S. Pat. No. 6,347,507) mounted ram jets on the tip of a rotor and eliminated, not only the internal rotor of the turbine but the internal rotor of the compressor as well. The philosophy behind what was intended to be the ultimate low tech engine is then promptly contradicted by a high tech rotor which must withstand the enormous rotational stresses due to Mach 2.5 tip speeds. In addition to air friction losses, fuel delivery or exhaust gas problems, the engine has what might be considered contradictory design points in a conventional engine. Since both propulsive efficiency and pressure ratio are always a function of the same parameter, tip speed, the engine designer has limited options to maximize overall efficiency.

### BRIEF SUMMARY OF THE INVENTION

The above problems are elegantly eliminated by the external rotor compressor in pending patent application Ser. No. 60/273,426 for an external rotor gas turbine. As with the McNaught and Lawler engines the internal rotor bladed element is eliminated thereby reducing the surface area of the expanding combustion gases, and, therefore, the film cooling requirements by an order of magnitude. Unlike the McNaught engine, however, the need for complicated rotating structures and seals is eliminated because the external rotor turbine on this engine is either attached to, or integral with, an external rotor dynamic compressor. The entire outside casing of the engine spins. Unlike the Lawlor engine, the dynamic compressor allows the engine designer to select and operate at any compression ratio over a broad range of tip speeds. The rotational stresses are greatly reduced at an optimum design point. With a counter rotating impulse turbine, rotational stresses may be reduced by up to an order of magnitude.

The high speed aircraft engine embodiment allows for top end speeds of a ram jet with ground take off capability.

### BRIEF DESCRIPTION OF THE DRAWINGS

FIG. 1 A cross section along the axis of the center of rotation of a prime mover for generating rotational shaft work 18. Air enters the external rotor axial compressor from the right side of the engine 20, and, after combustion in the axially mounted combustion chamber 14, the gases then move radially out to the tip mounted nozzles 2. The kinetic energy remaining in the exhaust gas jets is recovered by a one stage counter rotating impulse turbine 8 located in a radial direction from the nozzles and geared 10 to the reaction turbine. The fuel line is placed inside the hollow shaft 16.

FIG. 2 A cross section of an aircraft engine embodiment.

FIG. 3 A cross section with the combustion taking place near the rim of the jet rotor.

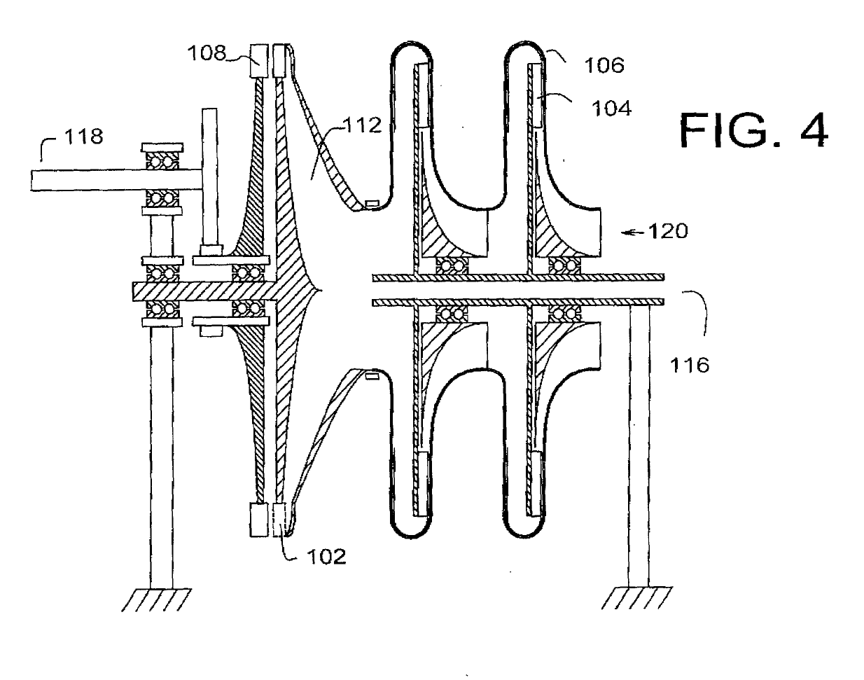

### DETAILED DESCRIPTION OF THE INVENTION

The external rotor compressor supplies the reaction turbine combustor with a sealless rotating source of compressed air. The reaction turbine nozzles are very similar to ram nozzles and allow for stoichiometric combustion temperatures with little or no film cooling. The fuel line, controls, pump, starter, combustor, regenerator and other peripherals could simply be routed through or mounted on the center of the compressor on the stator instead of on the outside casing in a conventional engine.

The design analysis requires only a conventional understanding of the basic principles of fluid mechanics, heat transfer, rotational stresses, and other turbomachinery fields. Except for the throat of the nozzles which may require some film cooling, the heat transfer on the outside of the spinning engine is in the same range as the inside. Computer modeling or simple rig tests can predict the exact heat transfer situation.

The external rotor gas turbine requires no scientific, technological, fabrication or other breakthroughs to design or to build. The outside of the external rotor of the axial compressor embodiment could be machined in one piece, preferably from a light alloy or titanium, then spin balanced and mounted on the internal stator. Ringed inserts alternately containing rotor and stator stages could then be loaded into the compressor. Alternatively, the compressor rotor could be built in two halves like a conventional compressor housing, and, attached with low profile radially symmetrical fittings after it is mounted onto the internal stator. The compressor could then be attached to a rotating combustor section or directly to the reaction turbine if the combustor was located in the radial flow or tip area of the engine. If film cooling was required, channels would route air from just downstream from the compressor to the nozzles.

Preferably, the nozzles in both the prime mover embodiment and the high speed thrust embodiment would be angled ten to 15 degrees the axial direction. The remaining kinetic energy would power a common axial impulse turbine for rotational shaft work or, for the high speed thrust engine, redirected aft off of stator blades.

I claim:

1. A gas turbine engine for producing high velocity exhaust gases via single stage expansion through nozzles comprising:
a rotating pressure vessel with one or more nozzles with a substantially tangential orientation mounted on, and in communication with, said pressure vessel wherein said nozzles produce reaction thrust torque from single stage expansion of combustion gases through said nozzles;
a dynamic compressor wherein one or more rotor stages are mounted on and powered by a rotating external shell attached directly to said pressure vessel thereby allowing for a rotating means of communication between said pressure vessel and said compressor;
one or more combustors located inside of said rotating pressure vessel;
a means for providing fuel to said combustors;
a means for mixing and combusting said fuel and air in said combustors;

2. The gas turbine engine of claim 1 wherein one or more stages of said dynamic compressor are of the axial flow type with said rotor stages attached to said external rotating shell.

3. The gas turbine of claim 1 wherein one or more stages of said dynamic compressor are of the centrifugal radial flow type with said rotor stages fixed to said external rotating shell.

4. The engine of claim 2 wherein one or more internal bladed stages are selected from a group containing fixed stator blade stages and counter rotating rotor blade stages.

5. The engine of claim 1 wherein said nozzles are oriented substantially toward an impulse turbine of one or more stages wherein the kinetic energy in said exhaust gas jets is converted to rotational shaft energy.

6. The engine of claim 5 wherein said Impulse turbine is located in a substantially axial direction direction from said nozzles.

7. The engine of claims 5 and 6 wherein one or more stages of said dynamic compressor are of the axial flow type with said rotor stages attached to said external rotating shell.

8. The engine of claims 5 and 6 wherein one or more stages of said dynamic compressor are of the centrifugal radial flow type with said rotor stages fixed to said external rotating shell.

9. The engine of claim 7 wherein one or more internal bladed stages are selected from a group containing fixed stator blade stages and counter rotating rotor blade stages.

10. The engine of claim 1 wherein said nozzles are oriented substantially toward stator blading wherein said kinetic energy in the exhaust gases is redirected in an axial direction for high speed propulsion.

11. The engine of claim 10 wherein said nozzles are oriented substantially axially toward stator blading wherein the kinetic energy in said exhaust gas jets is redirected in an axial direction.

12. The engine of claim 10 wherein one or more stages of said dynamic compressor are of the axial flow type with said rotor stages attached to said external rotating shell.

13. The engine of claim 10 wherein one or more stages of said dynamic compressor are of the centrifugal radial flow type with said rotor stages fixed to said external rotating shell,

14. The engine of claim 12 wherein one or more internal bladed stages are selected from a group containing fixed stator blade stages and counter rotating rotor blade stages.

15. The engine of claim 10 with an additional nozzle oriented axially on the center of rotation for axial thrust propulsion.
